(19) United States
(12) Patent Application Publication
(10) Pub. No.: US 2009/0013264 A1
(43) Pub. Date: Jan. 8, 2009

(54) Enhanced interactive electronic meeting system

(76) Inventors: Anand Ganesh Basawapatna, Greenwood Village, CO (US); Ashok Ram Basawapatna, Greenwood Village, CO (US)

Correspondence Address: Ashok Ram Basawapatna, 5157 South Boston Street, Greenwood Village, CO, 80111, US

(21) Appl. No.: 12/215,190

(22) Filed: Jun. 25, 2008

Related U.S. Application Data
(60) Provisional application No. 60/946,935, filed on Jun. 28, 2007.

(51) Int. Cl. G06F 3/048

(52) U.S. Cl. 715/753

(57) ABSTRACT

This invention integrates functionality to prior-art meeting system infrastructures that cannot be achieved by existing designs. The system allows for the creation of a meeting enabling multiple end user device combinations of varying compatibility—each device containing multiple different peripherals—to seamlessly two-way communicate and manage incoming and outgoing communications. An advantage is the ability to translate any feed data into a device compatible format. The invention enables end user context-independent subscription to an arbitrary number of data feeds originating from an arbitrary number of connected end users. Finally, the invention defines a meeting replay system using the invention infrastructure that has the ability to record any combinations of data feeds from any combinations of end users and replay any part of the meeting through the same invention-infrastructure. This allows prior meeting replaying through the invention-system, and allows cascading meeting replays ad-infinitum without altering the original meeting.

### FIELD OF THE INVENTION

This invention relates generally to electronic meeting systems, and more specifically, to a system enhancing and furthering the interactions of electronic meeting participants.

### DEFINITION OF TERMS

Device: Any electronics a user might user for communication purposes.

Peripherals: Anything attaching to a device that allows for or enhances device data input and output capability.

Feed: Data streams that users can request to receive.

Subscription: Receiving an authorized data feed being streamed from another user.

Connected User: The relationship between any group of users present in a meeting. Connected users can subscribe to one another's feeds, but no data is sent between connected users until this subscription occurs.

Device Incompatible Data: Data that cannot be properly reconstructed or displayed due to hardware, software or other incapabilities.

Display: Any device presentation of data including voice, video, tablet and other incoming data.

Administrator: Any person with the power to manage the meeting which may or may not include granting permissions to individual users to receive or transmit specific feeds or for some other action.

### BACKGROUND OF THE INVENTION

With the advent of computers and the ability to transfer data across a network, electronic meeting systems have started becoming commonplace in both the work and home environments. These systems can be everything from simple applications that allow for transfer of real-time instant messaging to more complex systems that allow for the exchange of video, audio, and other data among users. Prior art meeting systems allow users to work within the bounds of their current hardware/software configuration to communicate to users with similar setups. These systems typically require one to install specific software in order to participate in the meeting. If, for example, a given user device has no way of outputting sound, the electronic meeting software does not by itself allow the user to receive the information contained within incoming audio data. Furthermore, if someone could receive text data but preferred to receive the text data as an audio or video stream, or conversely has no way of receiving audio due to high ambient noise level and would prefer to receive the audio stream in text format, prior art meeting systems do not permit and, in fact, have no way to automatically enable such choice.

There are multiple prior art translation systems that convert data from one form to another making the data compatible, more manageable, and more economic to a given receiving system. These systems attempt to do everything from device independent messaging through telephony and network systems alike to translating text messages with abbreviations in order to reduce character length to allowing users to select from a valid format of transmission that is compatible with both users before electronic meeting interaction occurs. Many of these inventions serve the purpose of translating messages in some fashion; however, these inventions in no way give users the choice of format the data should be converted to—they all merely enable conversion to a compatible format. Some prior inventions that allow users to select the format of communication, assume both users will be using the same format instead of converting the messages to the preferred format of the receiving user. Furthermore, it should be pointed out that even if an incoming message is compatible, a user may want the data in a different format; prior art translation system inventions and prior art meeting systems typically do not give the receiving user a choice of format for a given incoming message. These characteristics indicate some of the prior art shortcomings regarding conversion and compatibility of data.

Prior art meeting systems allow users to remotely participate and interact with one another. However, when participating in a meeting, each user is not given access purely to the information they want. This is because end users cannot receive data out of context. If user A is connected to user B, in a typical electronic meeting system user A has access to all of user B's outgoing streams and user B has access to all of user A's outgoing streams. Thus, prior art meeting systems do not allow connected users to decide which specific feeds to send and receive on a feed by feed basis. However, it is clearly possible for an end user to prefer receiving real time audio from one connected user, real time streaming video from another connected user (without audio), and graphical tablet data from a third connected user and exclusively have this data appropriately presented together in a GUI. Furthermore, during the course of a meeting, a user may want to allow only a specific combination of users to see certain outgoing data; this should be allowed on an outgoing feed by feed basis. Prior art meeting systems do not allow such stream selection freedom among connected users.

In a system wherein a user is receiving and displaying multiple different data feeds from different connected users, it is necessary to give each user tools that allow for the management of incoming and outgoing data. For example, if a user currently has an arbitrary number of incoming audio streams, it should be possible for the user to separate these streams in a way that it is comprehendible. Users sending outgoing streams may want the ability to completely control who receives these streams and at what times; inherent in each stream should be permissions and stream suspension options. Furthermore, certain streams should have the capacity to be altered by other users given that the originating user permits the modification.

There have been many prior-art systems that allow for meeting replay and meeting annotation. Such systems are useful for people who may have not been present at a meeting to review and possibly add their own input to the meeting. However, many of these meeting replays do not fully integrate all the multimedia capabilities of prior meetings; thus, the user is not fully immersed in the meeting. Any meeting annotation system is inherently separate from the meeting, and any system which allows a user to asynchronously insert themselves into the meeting, in some respects, changes the original meeting. A system which allows a user or group of users to relive a meeting through the same viewpoint as a meeting participant and augment the meeting without inherently changing the original meeting or merely spectating, would enable the realization of a replay system that has all the advantages of both an annotation and asynchronous meeting replay. Moreover, a meeting replay system that allows for recording and replaying on a feed by feed level would enable users maximum freedom in recording and replaying a meeting; for example, the ability to record or not record any arbitrary combination of available streams for use in a meeting replay would give a user or an administrator the ability to record and replay important subsections or highlights of a given meeting.

In view of these prior art shortcomings, a system that provides a translational server allowing users to choose incoming feed formats, stream subscription on a feed by feed basis regardless of context, and a replay system wherein all components of the system work on a feed by feed basis, would allow for a meeting system tailored to each individual user's preferences.

### SUMMARY OF THE INVENTION

The present invention allows for an arbitrary group of users, each using a device containing an arbitrary number of peripherals, to connect and communicate by subscribing and receiving data streams on a feed by feed basis. Incoming streams can be received in any valid format compatible with the receiving end-user's device. Furthermore, a replay system, based on the stream subscription level and able to be served on an arbitrary combination of central servers and/or user machines, allows for an end-user or a group of end-users to replay a meeting in the form of another meeting.

Upon entering a meeting, a diagnostic server analyzes the entering device through network interaction. The diagnostic server is then able to create a device profile for a given device. This device profile outlines the different data formats that a given device can receive. If a data feed is intended for a given device but the data is incompatible with the device, the data is routed through a translational server; incompatible data is data that cannot properly be reconstructed or displayed due to hardware, software, and other device incapabilities. Using the device profile, the translational server either converts the data into a compatible format, or if more than one compatible format exists, determines which format to use based on user preference. Moreover, a user has the ability to convert incoming compatible data into other formats compatible with the user's device. Thus, a user can specify to have incoming compatible and incompatible data in another device compatible format; the data is then routed through a translational server, converted into that compatible format, and then sent to the user device.

During the course of a meeting, users interact with other connected users present in the meeting. Each connected user can have an arbitrary number of outgoing data feeds that other connected users can stream. Connected users are allowed to subscribe to each specific data feed that a given user streams without inherently subscribing to all or any combination of other data feeds; thus, the subscription is on a feed by feed basis. This subscription may also be subject to permissions. Users can subscribe to any combination of data feeds from any combination of connected users; users can allow any combination of outgoing data feeds to any combination of connected users. Feeds are allowed to be suspended for any arbitrary amount of time by the user originating the feed and possibly an administrator or authorized user.

To organize the multiple incoming feeds, the system provides some tools. A user has the ability to embed any incoming graphical data in a mosaic—this mosaic can include but is not limited to video data, white board data, web camera data, and data translated into a graphical format. Included in the mosaic is the ability to emphasize and/or deemphasize a combination of incoming video feeds. Users also have the ability to spatialize any incoming audio data as a source relative to the user's origin in virtual coordinates. Spatialized sounds can be emphasized through any combination of increasing the sound's volume relative to other incoming sounds and/or moving the sound's origin close to the user's origin in virtual space relative to other incoming sounds. Users can also pause, fast forward, and rewind any incoming data stream or group of data streams while receiving the stream. It is possible for users to access any past point in time of a given stream directly by typing that time into a stream window or combination of stream windows. In the situation wherein a user is receiving an incoming whiteboard stream, a user can, subject to permissions, contribute to the incoming whiteboard picture; this contribution is then viewable by all users subscribing to the whiteboard. Users have the ability to record any combination of incoming streams in both a stream format that can be replayed as a meeting replay (discussed below) and/or another format that is compatible with their given device. A central server can also record any data stream for replay purposes in a stream format at the request of users and/or a meeting administrator. Any stream recording may be subject to permissions, and any stream replay may be subject to permissions. Finally, a key word search and key name search allows users to search a real-time text transcription of incoming audio data and incoming text messages to find out at what time certain keywords may have been uttered by other users. The return result of this search is a list ordered in terms of relevance, hence called a relevance list.

A meeting replay system according to the present invention allows a user or group of users to relive a given meeting. A meeting can be based around a previous meeting's or meetings' replay allowing meeting users access to a previous meeting's or meetings' streams. All the replay streams in the meeting replay are sent to stream subscribers at the same time relative to the start of the meeting as they were in the original meeting. Users subscribe to various feeds, as they would in the original meeting, with the one possible difference being that the replay streams are originating from a user's device or from a central server and probably not from the device of original meeting participants. Connected users can then interact with one another during the course of a meeting replay; recording a meeting in which a replay is streamed allows meeting replays to be cascaded ad infinitum. Furthermore, recording permissions and viewing permissions for a meeting replay can be done on a feed by feed basis. Thus, a user or administrator can determine which combination of streams to record and which combination of users to allow viewing of each recorded stream.

### BRIEF DESCRIPTION OF THE DRAWINGS

A deeper understanding of the invention can be acquired when the following detailed description of the preferred embodiment is considered in conjunction with the following diagrams wherein:

FIG. 1 depicts a possible embodiment of connected end users participating in an electronic meeting;

FIG. 2 depicts a possible sequence of network interaction between the diagnostic server and a given device entering a meeting; this interaction culminates in a device profile;

FIG. 3 depicts a possible translational server flowchart starting from a device request of a given data stream;

FIG. 4 depicts the incoming and outgoing data streams through a possible embodiment of the connected users GUI; this GUI is from user A's perspective;

FIG. 5 depicts a possible flowchart of user A subscribing to one or a combination of user B's Feeds;

FIG. 6 depicts possible network data streams and network configurations in a ‘meeting replay’ meeting;

FIG. 7 depicts a possible mosaic video GUI;

FIG. 8 depicts a possible sound spatialization GUI;

FIG. 9 depicts a possible incoming video GUI;

FIG. 10 depicts a possible incoming white board GUI;

FIG. 11 depicts a possible flow chart of user A requesting to share user C's white board;

FIG. 12 depicts an embodiment of a keyword and key name search GUI culminating in a relevance list referring to the past utterances of the meeting thus far.

### DETAILED DESCRIPTION OF THE PREFERRED EMBODIMENTS

To better illustrate how this invention would work in an overall system, the drawings are now described in detail with the understanding that any of these depictions are merely examples, and the invention can easily work within different systems and configurations.

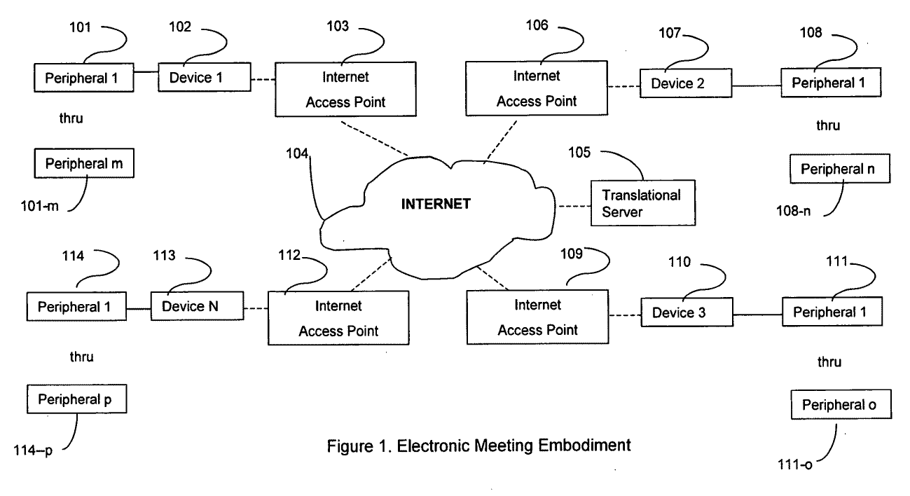

FIG. 1 depicts an embodiment of an electronic meeting wherein an arbitrary number of end users, each using a device 102,107,110,113 and each device containing various peripherals 101 through 101-m,108 through 108-n,111 through 111-o,114 through 114-p (wherein peripherals include but are not limited to graphical tablets, microphones, speakers etc.) connect to and participate in an electronic meeting with data being transferred over the Internet 104 or other network configuration. In this particular figure, a centralized translational server 105 is present in the realm of the Internet 104. The translational server 105 translates data in cases where either a user's particular device cannot handle or display data in a particular format because of incompatibility issues, or the user prefers to have the data in different format. It should be noted that the translational server 105 does not need to be centralized and can actually be any combination of centralized or distributed servers and distributed user computers all working in unison. Examples of Incompatible data are, but are not limited to, everything from physical limitations, such as if a device does not have a video screen to display video data, to other software and hardware incapabilities.

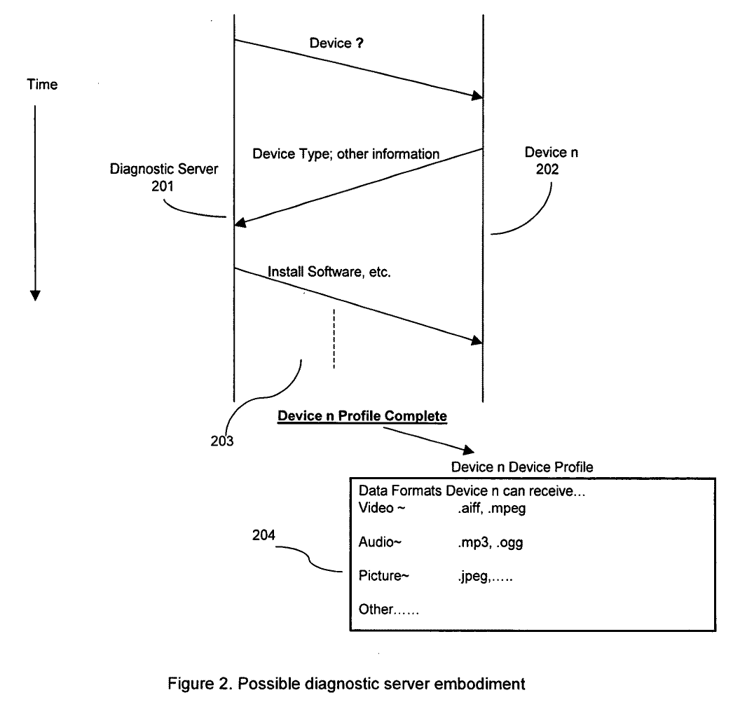

FIG. 2 depicts a possible diagnostic server 201 embodiment. The diagnostic server can consist of a centralized server or distributed servers, user computer or computers, or any combination thereof. The diagnostic server analyzes each incoming device 202 through various two-way network messages 203, and develops a device profile 204 wherein a particular device's physical, software, and other relevant characteristics are described. This device profile 204 is later used by the system to find out how to translate a stream to a given device. The diagnostic server 201 may or may not require software to be installed prior to diagnostic and can require manual user input as to certain device characteristics. The meeting system coupled with the translational server 105 only sends data to a device that fits one of the formats outlined in its device profile 204.

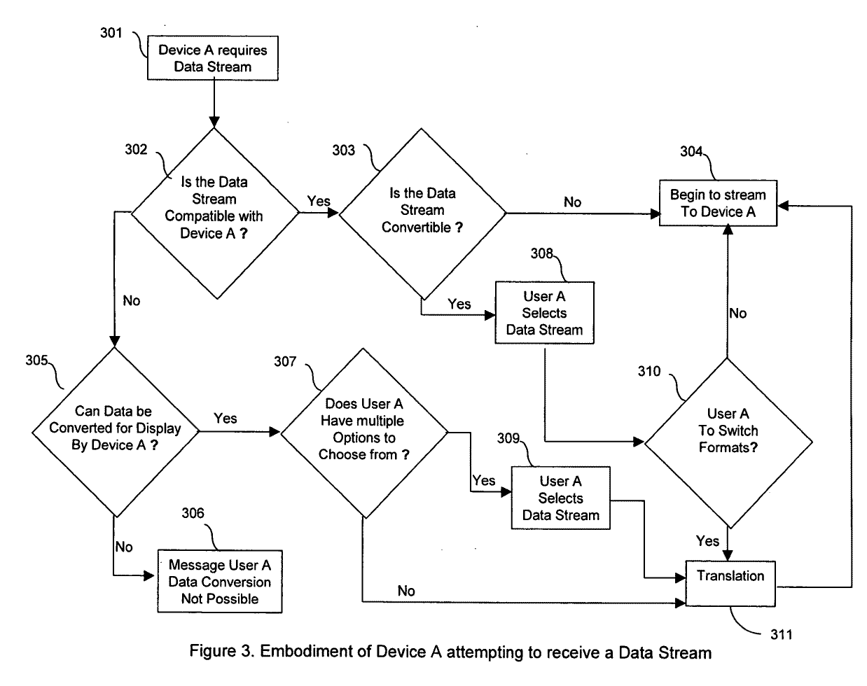

FIG. 3 depicts a possible flow chart of a given device, device A, attempting to receive a data stream from a connected user during the course of a meeting. Device A requests to receive the data stream 301; the system then analyzes whether the stream is compatible with the device 302. This is done by comparing the stream format to the already created device profile 204. If the stream is compatible, the system analyzes if device A has the ability to receive the data in another format 303; if so, then the system determines—either by querying user A, looking at user A's predefined preferences, or through some similar action 308—if the stream must be translated into a different format before being sent to device A 310. If the data must be translated, then the data is translated 311 using the translational server 105 before the stream is sent 304. If the stream is not compatible with device A 302, then the system determines if the data can be converted to a form displayable by device A 305 based on the device A's profile 204. If there is no valid data conversion, then user A is given a message stating that the stream cannot be received by user A's current device 306. Otherwise, if there is a valid data conversion, the system analyzes if there is more than one valid data conversion 307. If there is only one valid data conversion for device A, then the stream is converted to that format 311 and sent to the device 304. If there are multiple formats the stream can be converted to, then the system determines the format either by querying user A, using user A's predefined preferences, or through some similar action 309; after determining the format, the stream is subsequently translated 311 and sent to device A 304.

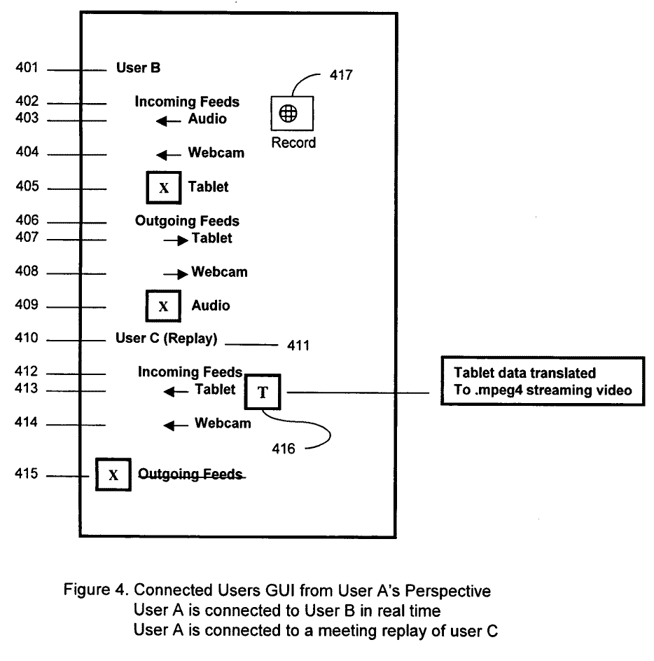

The system allows each user to subscribe to various other connected user streams regardless of context. Once users are connected, no data is transferred until a user successfully subscribes to another user's feed. This allows for a particular user to purely subscribe to feeds the user deems necessary and not be forced to receive data the user did not explicitly request. FIG. 4 depicts a possible embodiment of the connected users GUI from user A's perspective. In this particular meeting, user A is connected to user B 401 and a replay 411 of user C 410 (the replay system will be described in detail later). Under user A's Incoming Feeds from user B 402, one can see the current incoming feeds denoted with an incoming arrow (‘<--’). The feeds from user B to user A include audio 403 and web camera data 404. An ‘X’ beside a feed denotes that this feed is not currently subscribed to. If we look under user A's incoming feeds from user B 402, one can see that user A has currently not subscribed to user B's tablet data 405. Similarly, looking under user A's outgoing data feeds to user B 406, denoted with an outgoing arrow (‘-->’), one can see that user B has currently subscribed user A's tablet 407 and user A's web camera 408. User B has not subscribed to user A's audio feed 409. User C 410 is an incoming replay feed 411 to user A; this signifies that user C's streams are being replayed from a previous meeting and being sent to user A (and possibly user B) at the same relative time to the start of the meeting as user C sent the data in the original meeting. User A has an incoming replay tablet 413 and replay web camera 414 feed from user C. Since user C is a replay connection, user C is not physically present at the current electronic meeting, and thus, user C cannot subscribe to user A's outgoing feeds 415. User C's incoming tablet feed 413 is marked with a translation icon ‘T’. This denotes that the incoming tablet feed is translated. It is possible for user A to get more information regarding this translation by right clicking on the incoming feed in the connected users window or by some similar mechanism; the system should display a message that informs user A of the original data format and the current format the data is being translated to 416. In the current scenario, the tablet data from user C is being translated into MPEG 4 streaming video; however, it is possible that the data could be translated to a pure text feed or another graphical format or displayed in some other data format depending on the user's device profile, preferences, and the capabilities of the translational server. It is possible to pause, rewind, and fast forward any incoming audio feed; furthermore, it is possible to record, pause recording, and stop recording an incoming audio feed 417 in a replay stream format or another audio format.

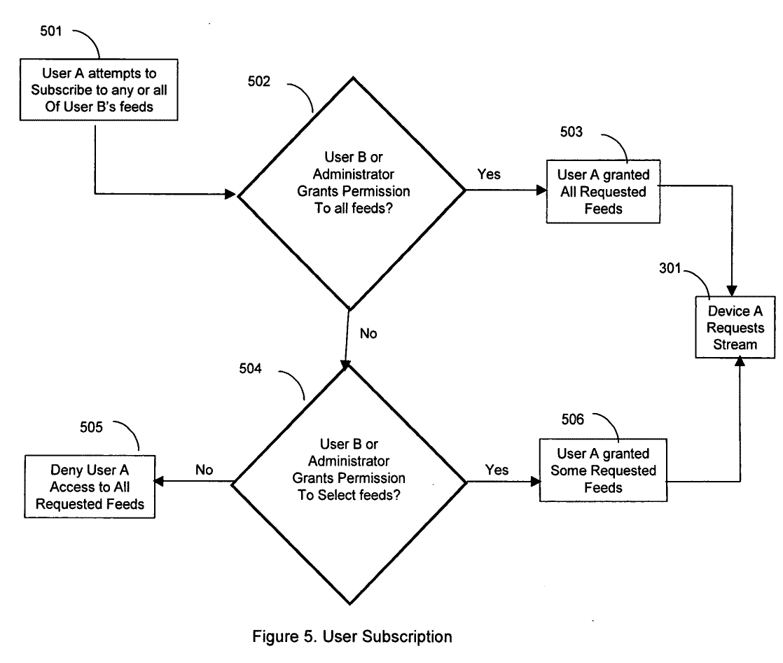

Depicted in FIG. 5 is a flowchart of user A attempting to subscribe to user B's feed. User A initially attempts to subscribe to one or a combination of user B's data feeds 501; user B or an administrator is thereupon asked whether or not to give user A permission to all of the requested feeds 502. If user B or administrator decides to give user A permission to all the requested feeds, then user A gets access to all the data feeds specified 503. If user B or an administrator decides to not give user A access to all requested feeds, then the system queries user B or an administrator as to whether to allows user A access to any of the requested feeds 504. If user B allows user A access to a subset of the requested feeds, then user A is given access to these specified feeds 506; otherwise, user A is denied access to all requested feeds 505. It should be noted that if user A is granted access to any of user B's feeds 503,506, then the flow chart continues onto FIG. 3 wherein the system must determine the stream format to send device A 301.

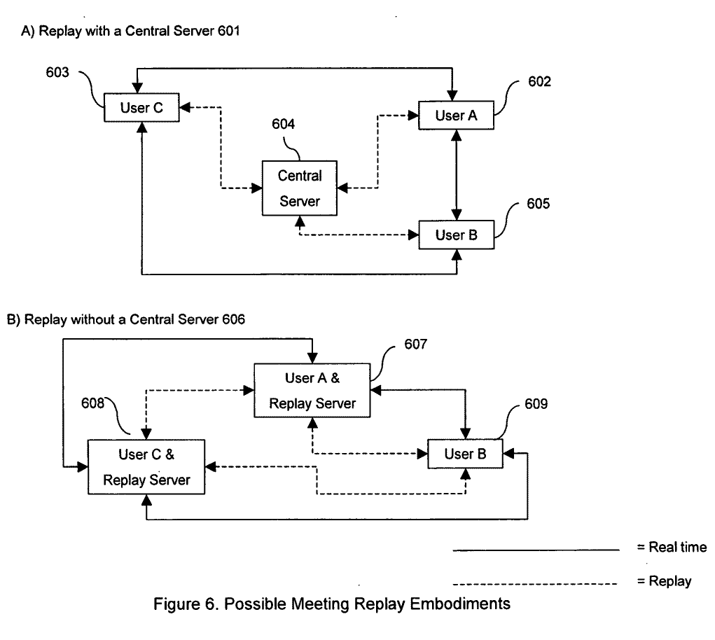

FIG. 6 depicts two possible embodiments of network interactions between users during a meeting replay. Depicted in one embodiment is a replay with a central server 601. The meeting takes place between user A 602, user B 605, user C 603, and a central server 604 that sends replay feeds. In this meeting user A 602, user B 605, and user C 603 send real-time messages to one another; furthermore, user A 602, user B 605, and user C 603 send requests for replay stream subscriptions to and receive replay messages from the central server 604. Another embodiment depicts user A 607 and user C 608 both serving parts of the replay data feeds 606; Thus, multiple users can serve a portion of the replay for all replay meeting users. As in the previous embodiment—user A 607, user B 609, and user C 608 can send and receive data streams to one another just like in a normal meeting.

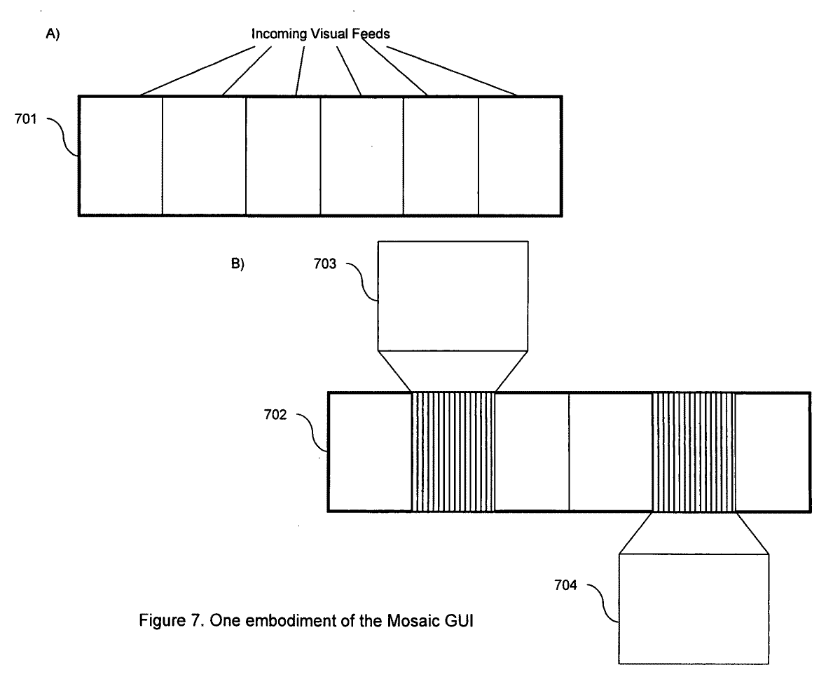

FIG. 7 depicts a possible embodiment of the mosaic in two states. The mosaic allows a user to receive multiple visually oriented feeds or feeds translated into a visual form and display this data in a group of concise windows. The first state shows all the incoming visually oriented streams displayed in a row mosaic 701. The second state 702 shows the mosaic picture GUI with two mosaic windows emphasized 704,703. The ability to emphasize allows a user to see a specific mosaic window in more detail.

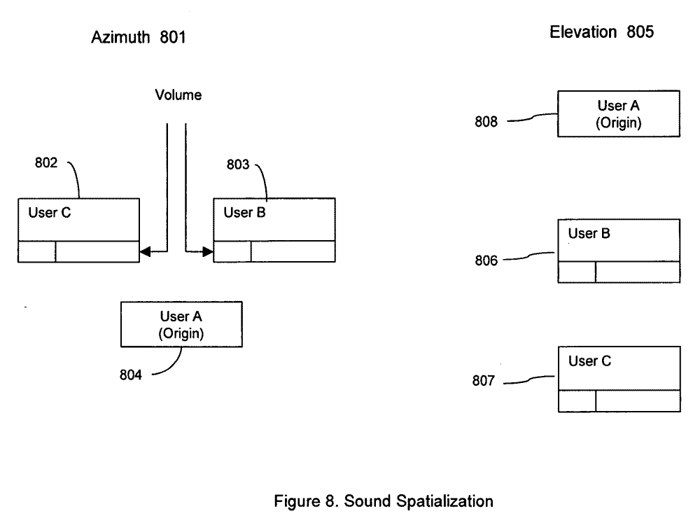

FIG. 8 depicts a possible embodiment of the sound spatialization GUI from user A's perspective in a meeting with user B and user C. The GUI allows user A to place incoming audio from other users in a virtual distance, including orientation information, relative to the user A who represents the origin (0,0). 801 depicts the azimuthal distance which is the distance relative to user A on user A's horizontal plane. User A places user B 803 and user C 802 at an azimuthal distance from user A which allows the incoming audio from user B and user C to each feel like it is originating from a given direction. 805 depicts the elevation distance which is the distance relative to user A 808 on user A's vertical plane or the height relative to user A. Similarly, user A 808 places user B 807 and user C 806 at an elevation point which allows user B 807 and user C's 806 incoming audio to sound like it is originating from these elevations respectively. Thus, the combination of specifying an elevation and azimuth relative to oneself defines an origin from which the sound is perceived to originate. The spatialized incoming sound can be emphasized by moving an incoming user closer to ones own origin or increasing the incoming user's audio volume. Finally, it should be noted that multiple incoming sounds from a single user can also be spatialized individually.

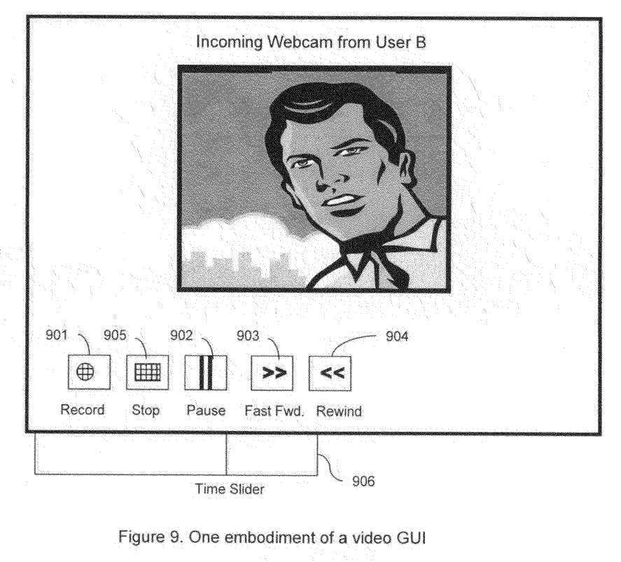

FIG. 9 depicts a possible embodiment for the incoming video GUI. The video GUI allows for a user to record a given feed 901, pause an incoming feed 902, fast forward a feed up to present time 903, rewind a feed up to the starting time of the feed 904, and finally stop recording the incoming feed 905. The time slider 906 allows a user to randomly access a given time in the feed by sliding time to the appropriate place or typing it in.

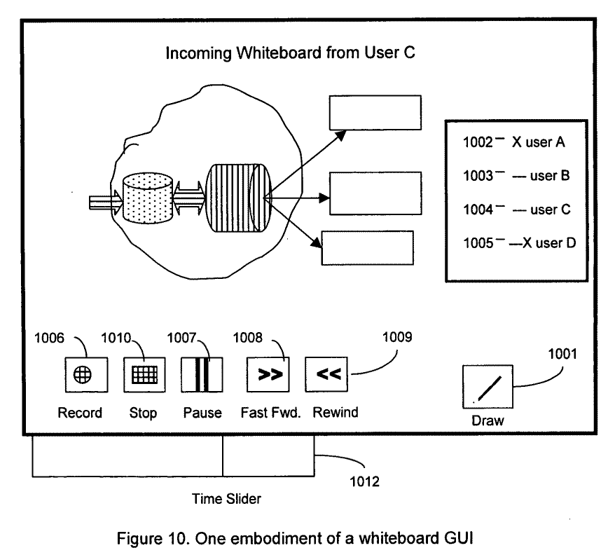

FIG. 10 depicts a possible embodiment of the white board GUI. Similarly to the video GUI, the white board GUI allows for a user to record an incoming feed 1006, pause an incoming feed 1007, fast forward a feed up to present time 1008, rewind a feed up to the start time of the feed 1009, and stop the recording of an incoming feed 1010. It is possible for a user to draw on another user's incoming white board feed by clicking the draw button 1001. If the originating user or an administrator allows for the sharing of the incoming feed, then multiple users can draw on the same white board. The top right of the white board lists the contributing users to the white board. In this case, user A 1002, user B 1003, user C 1004, and user D 1005 are all contributing to user C's board. It is possible for a user subscribing to the white board feed to filter out each persons contribution to the white board; in this current embodiment, users with X's by their name are currently being filtered out, namely, user A 1002 and user D 1005. Each user can be automatically assigned a color or the originator can assign a color for each user. Alternatively, different parts of a drawing, e.g. blocks can be assigned different colors.

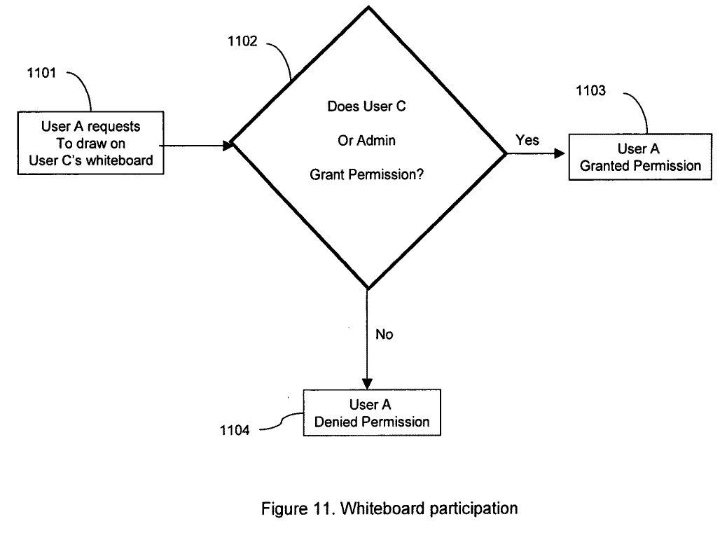

FIG. 11 shows the flowchart of user A requesting to draw on user C's white board. User A requests to draw on user C's white board 1101; user C or an administrator then decides whether to let user A draw on the white board 1102. If user C or an administrator allows user A to draw on the white board, then every person who has subscribed to user C's white board feed will also receive user A's contribution to the white board; otherwise, if user C denies user A, then user A is prohibited from drawing on user C's white board 1104.

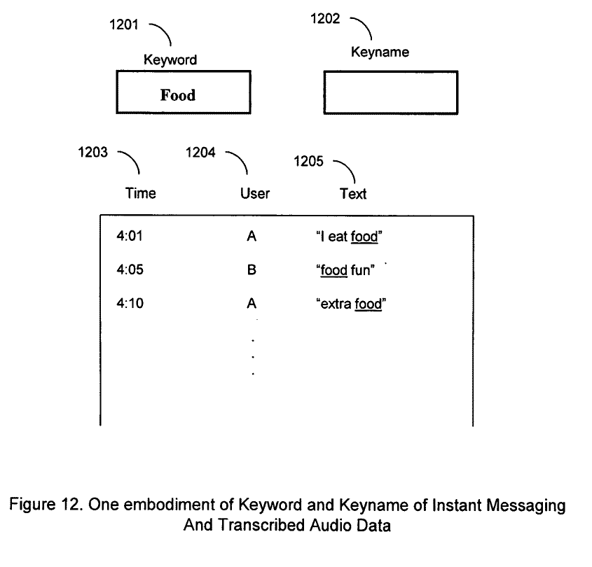

FIG. 12 depicts the keyword search of a current meeting. During the course of a meeting every audio is converted in real time to text as a transcript. Furthermore, any text interaction, such as instant messaging, is also included in the text transcript. Thus, it is possible for a user to keyword search any past utterance and find at what time related things were uttered 1201. Furthermore, users can also search by name using a key name search 1202. The key word and key name search can be cross referenced with one another. A relevance list is returned with the related utterances 1205, the user who uttered the phrase 1204, and the time the phrase was uttered either relative to the start of the meeting or global time or some similar time 1203.

What is claimed is:

1. A collaborative online meeting system wherein a plurality of end-users each utilizing
a) Different communication devices with varying data display capabilities
b) A variety of peripherals attached to these devices that allow for different modalities of communication
participate in an online meeting via a meeting system architecture that enables device-incompatible data to be displayed in a form suited for any given device;
wherein, upon a new end user device entering a given meeting, a diagnostic server, through interaction with each newly entering device, obtains a device profile outlining the compatible and incompatible data types of the entering device including any device hardware and software capabilities;
wherein, data incompatible to a given device has the ability to be translated, in real time, into a form receivable and displayable by the device;
wherein, a translational server utilizing the device profile, previously created by the diagnostic server, translates any incompatible data into a form receivable and displayable by any device receiving the data.

2. The system of claim 1 wherein any end user receiving incoming translated data can specify the form of the incoming translated data if the data can be translated into two or more forms compatible with the end user's device as outlined by the device profile.

3. The system of claim 1 wherein any end user receiving non-translated incoming data compatible with the end user's device can elect to have the data translated into any other form compatible with end user's device as specified by the end user and based upon the device profile.

4. The system of claim 1 whereby a given device, subject to its device profile, can have the option of embedding any combination of incoming visual data, including translated data displayed in a visual form, in a mosaic;
wherein a mosaic consists of embedding the windows of any combination of incoming visual data together into a single larger window.

5. The system of claim 4 whereby each end-user has the ability to emphasize any combination of incoming mosaic feeds by enlarging these feeds' housing window with respect to the other graphical feeds in the mosaic;
wherein, an end user also has the ability to deemphasize any combination of previously emphasized incoming mosaic graphical feeds.

6. The system of claim 1 wherein each end user can spatialize any combination of incoming audio data, including translated data displayed in an auditory form, by specifying, in distance including orientation—with respect to the end user, a virtual origin for the incoming audio.

7. The system of claim 6 wherein each end user can elect to emphasize any combination of currently spatialized sounds by moving the sound's virtual origin closer to the end-user's virtual position or increasing the sound's volume with respect to other spatialized audio or any combination thereof,
wherein, an end user has the ability to deemphasize any combination of previously emphasized incoming spatialized audio feeds by moving the sound's virtual origin back to its original position or decreasing its volume or any combination thereof.

8. The system of claim I wherein an end user has the ability to pause, fast forward, and rewind any combination of incoming displayed streams including incoming translated streams.

9. The system of claim 1 wherein an end user has the ability to record, pause recording, stop recording and save the recording of any combination of incoming visual data feeds, including feeds translated into the visual data form, in both a video format or as a meeting replay stream format or any combination thereof.

10. The system of claim 9 whereby feed recording is subject to the permission of the end user originating the feed or any other user with sufficient permissions.

11. The system of claim I wherein an end user has the ability to record, pause recording, stop recording, and save the recording of any combination of incoming audio feeds, including feeds translated into the audio form, in both an audio format or as a meeting replay stream format or any combination thereof.

12. The system of claim 11 whereby feed recording is subject to the permission of the end user originating the feed or any end user with sufficient permissions.

13. The system of claim I whereby any incoming audio stream, including incoming streams translated to the audio form, can be converted to text format in real time and annotated with time and originating user information.

14. The system of claim 13 wherein any end user can keyword search, key name search, time search or search any combination thereof of the real time text information yielding a list, in order of relevance, every reference to that given keyword in the meeting with the time and originating user information corresponding to each returned reference.

15. The system of claim 1 wherein any end user can specify and access any past time of any combination of incoming feeds, including incoming translated feeds, in real time during a meeting.

16. A collaborative online meeting system wherein a plurality of end-users each utilizing
a) Different communication devices with varying data display capabilities
b) A variety of peripherals attached to these devices that allow for different modalities of communication
wherein each end user can attempt to subscribe to any combination of possible incoming feeds, regardless of audio, visual, or any other data context, that other connected end users stream during the course of a meeting;
wherein, any end user has the ability to subscribe to one feed at a time or a group of feeds at once or any combination thereof.

17. The system of claim 16 wherein any end user has the ability to un-subscribe to any combination of currently subscribed to incoming feeds;
wherein, an end user has the ability to un-subscribe to one feed at a time or a group of feeds at once or any combination thereof.

18. The system of claim 16 whereby the attempt of a given user to subscribe to another end user's outgoing feed is subject to the permission of the end user whereby the feed originates or any other user with sufficient permissions.

19. The system of claim 16 whereby an end user or can suspend any outgoing feed or group of outgoing feeds or any combination thereof to end users currently subscribing to the feed;
wherein a currently suspended feed can be unsuspended to any end user or group of end users at a single time or any combination thereof.

20. The system of claim 19 whereby an end user can suspend one or more feeds originating from another end user to a third connected end user given that the suspending end user has the correct permissions to suspend the specific feeds to the third connected end user.

21. The system of claim 16 whereby a given device, subject to its device profile, can have the option of embedding any combination of incoming visual data, including translated data displayed in a visual form, in a mosaic;
wherein a mosaic consists of embedding the windows of any combination of incoming visual data into a single larger window.

22. The system of claim 21 whereby each end-user has the ability to emphasize any combination of incoming mosaic feeds by enlarging these feeds' housing window with respect to the other graphical feeds in the mosaic;
wherein, an end user also has the ability to deemphasize any combination of previously emphasized incoming mosaic visual data feed.

23. The system of claim 16 wherein each end user can spatialize any combination of incoming audio data, including translated data displayed in an auditory form, by specifying, in distance—including orientation—with respect to the end user, a virtual origin for the incoming audio.

24. The system of claim 23 wherein each end user can elect to emphasize any combination of currently spatialized sounds by moving the sound's virtual origin closer to the end-user's virtual position or increasing the sound's volume with respect to other spatialized audio or any combination therein;
wherein, an end user has the ability to deemphasize any combination of previously emphasized incoming spatialized audio feed by moving the sound's virtual origin back to its original position or decreasing its volume or any combination therein.

25. The system of claim 16 wherein an end user receiving an incoming previously subscribed-to graphical tablet feed can draw on the same white board window currently displaying the incoming graphical tablet data; wherein the contributions of the end user is viewable to all who currently subscribe to the tablet feed.

26. The system of claim 25 whereby the end user's ability to draw on a currently subscribed-to graphical tablet feed originating from a connected user is subject to the permission of the end user wherefrom the graphical tablet feed originates or any other user with sufficient permissions;
wherein permission can be given and revoked at any time to any combination of contributing white board users.

27. The system of claim 25 whereby in the case of a group of end user's sharing the same white board, any end user subscribing to the white board and displaying the white board data in some form can filter out any combination of end user's contribution to the white board.

28. The system of claim 16 wherein an end user has the ability to pause, fast forward, rewind any combination of incoming displayed streams including incoming translated streams.

29. The system of claim 16 wherein an and user has the ability to record, pause recording, stop recording and save the recording of any combination of incoming graphical feeds, including feeds translated into the graphical form, in both a video format or as a meeting replay stream format or any combination thereof.

30. The system of claim 29 whereby feed recording is subject to the permission of the end user originating the feed or any other user with sufficient permissions.

31. The system of claim 16 wherein an end user has the ability to record, pause recording, stop recording, and save the recording of any combination of incoming audio feeds, including feeds translated into the audio form, in both an audio format or as a meeting replay stream format or any combination thereof.

32. The system of claim 31 whereby feed recording is subject to the permission of the end user originating the feed or any other user with sufficient permissions.

33. The system of claim 16 whereby any incoming audio stream, including incoming streams translated into the audio form, can be converted to text format in real time and annotated with time and originating user information.

34. The system of claim 33 wherein any end user can keyword search, keyname search, time search or any combination therein of the real time text information yielding a list in order of relevance every reference to that given keyword in meeting with the time and originating user information corresponding to each returned reference.

35. The system of claim 16 wherein any end user can specify and access any past time of any combination of incoming feeds including incoming translated feeds in real time during a meeting.

36. A collaborative online meeting system wherein a plurality of end-users each utilizing
a) Different communication devices with varying data display capabilities
b) A variety of peripherals attached to these devices that allow for different modalities of communication to participate in an online meeting using a meeting replay system wherein a central server or user computers or some combination thereof enables
i) Recording of any combination of subscription feeds of any end user in the meeting in the original feed format. This recording is stored either on a central server or an end user's device or group of end user's devices.
ii) Creation of a meeting based around a replay of a previously recorded meeting;
wherein end users participating in the meeting can subscribe to particular feeds of end users who were present in the original meeting but may or may not be present in the current meeting; wherein replay data is sent at the same time relative to the start of the meeting as the data was previously sent at the original meeting;
wherein a meeting based around a meeting replay can also be replayed. Meeting Replays can thus be cascaded ad infinitum.

37. The system of claim 36 whereby any meeting replay stream subscriptions are subject to the previously authorized permissions of the end user originating said stream or any other user with sufficient permissions.

38. The system of claim 36 whereby a given device, subject to its device profile, can have the option of embedding any combination of incoming visual data and replay visual data, including translated data and replayed translated data displayed in a visual form, in a mosaic; wherein a mosaic consists of embedding the windows of any combination of incoming visual data into a single larger window.

39. The system of claim 38 whereby each end-user has the ability to emphasize any combination of incoming mosaic feeds by enlarging these feeds' housing window with respect to the other graphical feeds in the mosaic;
wherein, an end user also has the ability to deemphasize any combination of previously emphasized incoming mosaic visual data feed.

40. The system of claim 36 wherein each end user can spatialize any combination of incoming audio data and replay audio data, including translated data displayed in an audio form and replay translated data displayed in an audio form, by specifying, in distance—including orientation—with respect to the end user, a virtual origin for the incoming audio.

41. The system of claim 40 wherein each end user can elect to emphasize any combination of currently spatialized sounds by moving the sound's virtual origin closer to the end-user's virtual position or increasing the sounds volume relative to other spatialized sounds or some combination thereof;
wherein, an end user has the ability to deemphasize any combination of previously emphasized incoming spatialized audio feed by moving the sound's virtual origin back to its original position or decreasing its volume or some combination thereof.

42. The system of claim 36 wherein an end user receiving an incoming previously subscribed-to graphical tablet feed can draw on the same white board window currently displaying the incoming graphical tablet data; wherein the contributions of the end user is viewable to all who currently subscribe to the tablet feed.

43. The system of claim 42 whereby the end user's ability to draw on a currently subscribed-to graphical tablet feed originating from a connected user is subject to the permission of the end user whereby the graphical tablet feed originates;
wherein permission can be given for any period of time and revoked at any time to any combination of contributing white board users.

44. The system of claim 42 whereby in the case of a group of end user's sharing the same white board, any end user subscribing to the white board and displaying the white board data in some form can filter out any combination of end user's contribution to the white board.

45. The system of claim 36 wherein an end user has the ability to pause, fast forward, and rewind any combination of incoming displayed streams including incoming replay streams, translated streams, and translated replay streams;
wherein, replay feeds can be fast-forwarded to their temporal end whereas real time feeds can only be fast forwarded to present time.

46. The system of claim 36 wherein an end user has the ability to record, pause recording, stop recording and save the recording of any combination of incoming graphical feeds, graphical replay feeds, feeds translated into the graphical form, and replay feeds translated into the graphical form in both a video format or as a meeting replay stream format or any combination thereof.

47. The system of claim 46 whereby feed recording is subject to the permission of the end user originating the feed or any other user with sufficient permissions.

48. The system of claim 36 wherein an end user has the ability to record, pause recording, stop recording, and save the recording of any combination of incoming audio feeds or replay audio feeds, including feeds and replay feeds translated into the audio form, in both an audio format or as a meeting replay stream format or any combination thereof.

49. The system of claim 48 whereby feed recording is subject to the permission of the end user originating the feed or any other user with sufficient permissions.

50. The system of claim 36 whereby any incoming audio stream, replay audio stream, and incoming streams and replay streams translated to the audio form, can be converted to text format in real time and annotated with time and originating user information.

51. The system of claim 50 wherein any end user can keyword search, key name search, time search or any combination therein of the real time text information yielding a list in order of relevance every reference to that given keyword in the meeting with the time and originating user information corresponding to each returned reference.

52. The system of claim 36 wherein any end user can specify and access any past time of any combination of incoming feeds, replay feeds, and incoming translated feeds and translated replay feeds in real time during a meeting.
